(19) United States
(12) Patent Application Publication
(10) Pub. No.: US 2005/0275293 A1
(43) Pub. Date: Dec. 15, 2005

(54) System for integrating linear motion guide and linear induction motor

(75) Inventors: Do Hyun Kang, Changwon-si (KR); Jong Bo Ahn, Changwon-si (KR); Ji Won Kim, Boosan-si (KR); Jung Hwan Chang, Changwon-si (KR)

Correspondence Address: ROTHWELL, FIGG, ERNST & MANBECK, P.C., 1425 K STREET, N.W., SUITE 800, WASHINGTON, DC, 20005, US

(73) Assignee: KOREA ELECTROTECHNOLOGY RESEARCH INSTITUTE, Changwon (KR)

(21) Appl. No.: 10/965,212

(22) Filed: Oct. 15, 2004

(30) Foreign Application Priority Data
Jun. 10, 2004 (KR) 10-2004-0042442

(51) Int. Cl. H02K 41/00

(52) U.S. Cl. 310/12

(57) ABSTRACT

The present invention provides a system for integrating a linear motion guide and a linear induction motor that can commonly employ a stationary member between the linear induction motor and the linear motion guide so that a complicated connection structure between a conventional linear motion guide and a conventional linear induction motor can be removed. In the system, a stationary unit interconnects a stationary member of the linear motion guide and a stationary member of the linear induction motor, and a movable unit interconnects a movable member of the linear motion guide and a movable member of the linear induction motor. As an existing linear transport device requiring both the linear induction motor and the linear motion guide can be simplified, an installation space of the device can be reduced, device manufacturing and maintenance costs can be reduced, and clean straight-line transport can be implemented.

### BACKGROUND OF THE INVENTION

1. Field of the Invention

The present invention relates to a system for integrating a linear induction motor with a linear motion guide so that a linear motion generation device can be simplified.

2. Description of the Related Art

As a means for obtaining power for straight-line motion of a linear transport device, a hydraulic or pneumatic system or a power transmission system such as a rotated motor or etc. is used, as well-known. However, these systems have a disadvantage in that a system structure is complicated and also system manufacturing and maintenance costs are high.

To address the above-described disadvantage, a linear transport device adopting a linear motor has been recently developed. The linear motor directly causes straight-line motion, so the linear motor need not a power transmission system and the structure of the linear motor is simple. The linear motor applied to the linear transport device is disposed independently of a linear motion guide that guides linear transport.

However, because the linear motor and the linear motion guide must be independently disposed to perform the linear transport in the conventional linear transport device adopting the linear motor, there is a problem in that a structure of the conventional linear transport device is complicated and, device manufacturing and maintenance costs are high.

### SUMMARY OF THE INVENTION

Therefore, the present invention has been made in view of the above and other problems, and it is an object of the present invention to provide a system for integrating a linear motion guide and a linear induction motor that can commonly employ a stationary member between the linear induction motor and the linear motion guide so that a complicated connection structure between a conventional linear motion guide and a conventional linear induction motor can be removed.

In accordance with an aspect of the present invention, the above and other objects can be accomplished by the provision of a system for integrating a linear motion guide and a linear induction motor, comprising: a stationary unit for interconnecting a stationary member of the linear motion guide and a stationary member of the linear induction motor; and a movable unit for interconnecting a movable member of the linear motion guide and a movable member of the linear induction motor.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating the overall structure of a system for integrating a linear motion guide and a linear induction motor in accordance with the present invention;

FIG. 2 is a side view illustrating the system in accordance with the present invention;

FIG. 3 shows the structure of a movable member of the linear induction motor applied to the system in accordance with the present invention;

FIG. 4a shows the structure of a core provided in the movable member of the linear induction motor applied to the system in accordance with the present invention;

FIG. 4b shows the structure of a laminated core provided in the movable member of the linear induction motor in accordance with the present invention; and

FIG. 5 shows the structure of windings provided in the movable member of the linear induction motor in accordance with the present invention;

FIG. 6 is a perspective view illustrating the unification structure of the core and the conductor for the stationary member of the linear induction motor in the system for integrating a linear motion guide and a linear induction motor in accordance with the present invention;

FIG. 7 is a side view illustrating the unification structure in the system in accordance with the present invention.

### DETAILED DESCRIPTION OF PREFFERRED EMBODIMENTS

Now, preferred embodiments of the present invention will be described in detail with reference to the annexed drawings.

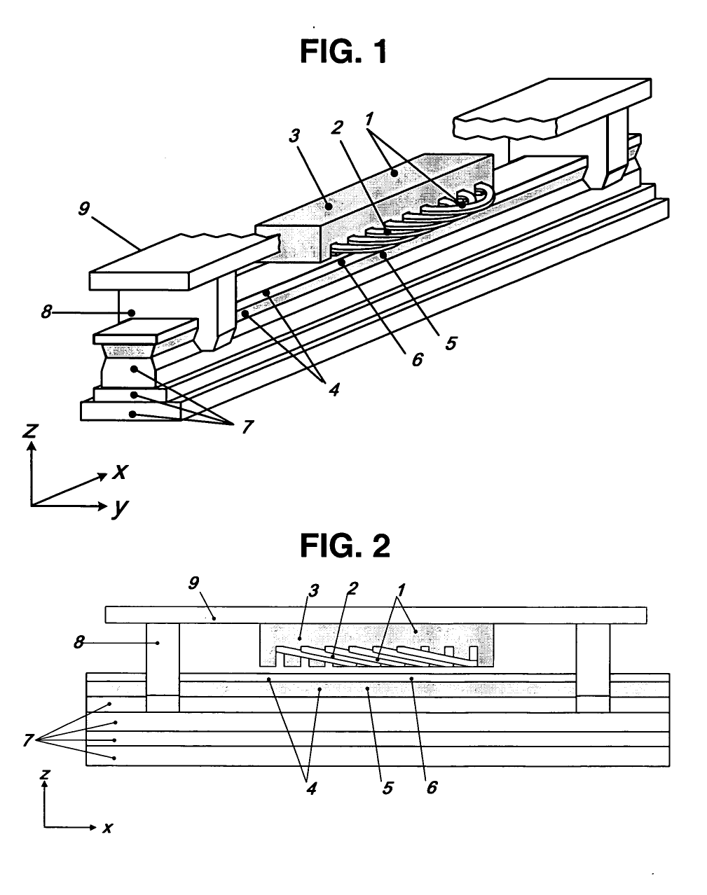

FIG. 1 is a perspective view illustrating the overall structure of a system for integrating a linear motion guide and a linear induction motor in accordance with the present invention; and FIG. 2 is a side view illustrating the system in accordance with the present invention.

As shown in FIGS. 1 and 2, a movable member 1 of the linear induction motor provided in the system of the present invention includes windings 2 and a core 3. The windings 2 are inserted into slots formed in a side surface of the core 3.

The movable member 1 is coupled to a support 9 of the linear induction motor so that the movable member 1 can be supported by the support 9. The support 9 is coupled to a moveable member 8 of the linear motion guide. Accordingly, the moveable member 1 of the linear induction motor can be coupled to the movable member 8 of the linear motion guide by means of the support 9 of the linear induction motor.

A stationary member 4 of the linear induction motor is seated on supports 7 of the linear motion guide in a state in which a core 5 and a conductor (or panel) 6 for the stationary member 4 of the linear induction motor are stacked. Here, the conductor 6 of the stationary member 4 is composed of an aluminum or copper material.

An operational principle of the system configured as described above is as follows. When a three-phase current is applied to the windings 2 of the movable member 1 for the linear induction motor, a magnetic flux is generated. An eddy current is induced from the conductor 6 of the stationary member 4 for the linear induction motor by a moving magnetic field, and hence a thrust is generated. Consequently, the core 5 can generate a large magnetic flux with a small three-phase current of the windings 2 by reducing magnetic resistance in a magnetic circuit.

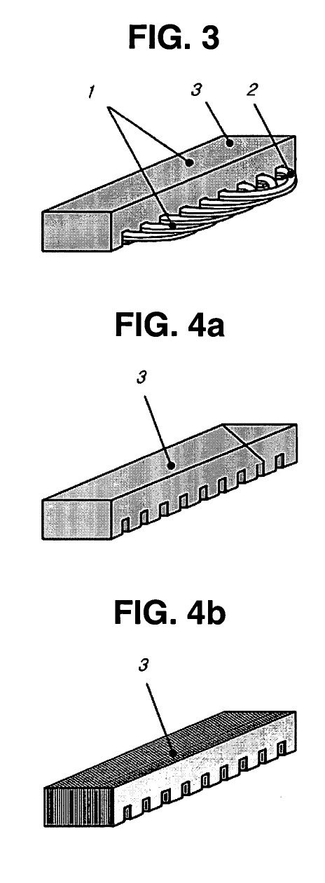

FIG. 3 is a perspective view illustrating the movable member of the linear induction motor in the system for integrating the linear motion guide and the linear induction motor in accordance with the present invention. In the movable member 1 of the linear induction motor as shown in FIG. 3, the windings 2 are inserted into slots formed in the side surface of the core 3.

When the linear transport device to which the system of the present invention is applied needs to operate at a slow speed, the core 3 of the linear induction motor can be manufactured in an unlaminated form, as shown in FIG. 4a, because power supply frequency is not relatively high. Manufacturing cost can be reduced according to the core 3 based on the unlaminated form, and a structure having durability can be produced.

On the other hand, when the linear transport device to which the system of the present invention is applied needs to operate at a fast speed, the core 3 of the linear induction motor can be manufactured in a laminated form, as shown in FIG. 4b, because power supply frequency is relatively high. The laminated core 3 can reduce eddy current loss and hysteresis loss capable of being caused in the core 3 of the movable member.

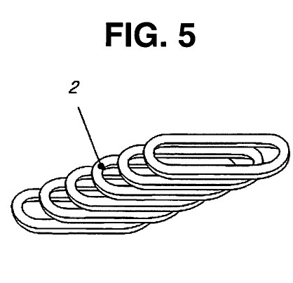

FIG. 5 shows a structure of the windings provided in the movable member of the linear induction motor in accordance with the present invention. As in a typical three-phase linear induction motor, the windings 2 of the movable member are spatially alternately wrapped on the basis of three phases A, B and C. Accordingly, when three phase power components temporally having 120-degree phase differences are applied to the windings 2, a moving magnetic field is generated.

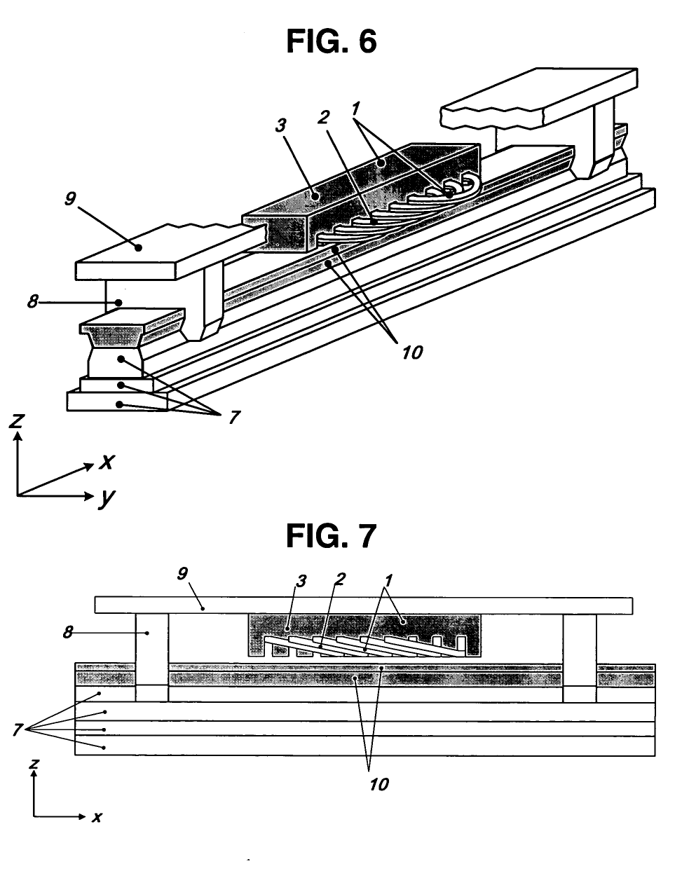

FIG. 6 is a perspective view illustrating the unification structure of the core and the conductor for the stationary member of the linear induction motor in the system for integrating a linear motion guide and a linear induction motor in accordance with the present invention, and FIG. 7 is a side view illustrating the unification structure in the system in accordance with the present invention. Instead of being composed of the core 5 for the stationary member 4 of the linear inductor motor and the conductor 6 for the stationary member 4 separately, the stationary member 10 of the linear induction motor in accordance with the embodiment of the FIG. 6 and FIG. 7 has a structure in which the core and the conductor is unified.

In order that the stationary member simultaneously includes the function of a magnetic substance enabling magnetic flux to flow well and the function of a conductor enabling electric current to flow well, the core and the conductor for the stationary member of the linear induction motor are unified. Accordingly, the unified stationary member of the linear inductor motor becomes more simplified and generates a thrust greater than the stationary member composed of the core and the conductor separately.

As apparent from the above description, the present invention can simply implement a linear motion generation device by integrating a linear induction motor with a linear motion guide, reduce an installation space of the device, reduce device manufacturing and maintenance costs and implement clean straight-line transport.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A system for integrating a linear motion guide and a linear induction motor, comprising:
a stationary unit for interconnecting a stationary member of the linear motion guide and a stationary member of the linear induction motor; and
a movable unit for interconnecting a movable member of the linear motion guide and a movable member of the linear induction motor.

2. The system of claim 1, wherein the stationary unit comprises:
the stationary member of the linear induction motor fixed and seated on at least one support of the linear motion guide.

3. The system of claim 2, wherein the stationary member of the linear induction motor comprises:
a core of the stationary member; and
a conductor of the stationary member, the conductor being stacked along with the core.

4. The system of claim 3, wherein the conductor of the stationary member for the linear induction motor is composed of any one conductive material of aluminum and copper.

5. The system of claim 1, wherein the movable unit comprises:
the movable member of the linear induction motor; and
the movable member of the linear motion guide coupled to the movable member of the linear induction motor by means of a support.

6. The system of claim 5, wherein the movable member of the linear induction motor comprises:
windings of the movable member inserted into slots formed in a side surface of a core of the movable member.

7. The system of claim 6, wherein a laminated form in the core of the movable member for the linear induction motor is determined by a slow or fast motor transport speed.

8. The system of claim 2, wherein the stationary member of the linear induction motor has a structure in which the function of a magnetic substance enabling magnetic flux to flow and the function of a conductor enabling electric current to flow are unified.

9. The system of claim 1, wherein an eddy current is induced in a conductor of the stationary member for the linear induction motor by a moving magnetic field generated from a three-phase current applied to windings of the movable member for the linear induction motor, and hence a thrust is generated.

10. The system of claim 2, wherein an eddy current is induced in a conductor of the stationary member for the linear induction motor by a moving magnetic field generated from a three-phase current applied to windings of the movable member for the linear induction motor, and hence a thrust is generated.

11. The system of claim 3, wherein an eddy current is induced in a conductor of the stationary member for the linear induction motor by a moving magnetic field generated from a three-phase current applied to windings of the movable member for the linear induction motor, and hence a thrust is generated.

12. The system of claim 4, wherein an eddy current is induced in a conductor of the stationary member for the linear induction motor by a moving magnetic field generated from a three-phase current applied to windings of the movable member for the linear induction motor, and hence a thrust is generated.

13. The system of claim 5, wherein an eddy current is induced in a conductor of the stationary member for the linear induction motor by a moving magnetic field generated from a three-phase current applied to windings of the movable member for the linear induction motor, and hence a thrust is generated.

14. The system of claim 6, wherein an eddy current is induced in a conductor of the stationary member for the linear induction motor by a moving magnetic field generated from a three-phase current applied to windings of the movable member for the linear induction motor, and hence a thrust is generated.

15. The system of claim 7, wherein an eddy current is induced in a conductor of the stationary member for the linear induction motor by a moving magnetic field generated from a three-phase current applied to windings of the movable member for the linear induction motor, and hence a thrust is generated.

16. The system of claim 8, wherein an eddy current is induced in a conductor of the stationary member for the linear induction motor by a moving magnetic field generated from a three-phase current applied to windings of the movable member for the linear induction motor, and hence a thrust is generated.
